(19) United States
(12) Patent Application Publication
(10) Pub. No.: US 2010/0033609 A1
(43) Pub. Date: Feb. 11, 2010

(54) SOLID STATE IMAGING DEVICE

(75) Inventors: Hiroshi KATO, Tokyo (JP); Katsumi Dosaka, Tokyo (JP); Fukashi Morishita, Tokyo (JP)

Correspondence Address: MCDERMOTT WILL & EMERY LLP, 600 13TH STREET, N.W., WASHINGTON, DC, 20005-3096, US

(73) Assignee: RENESAS TECHNOLOGY CORP.

(21) Appl. No.: 12/473,876

(22) Filed: May 28, 2009

(30) Foreign Application Priority Data
Aug. 6, 2008 (JP) 2008-202728

(51) Int. Cl. H04N 5/335

(52) U.S. Cl. 348/294; 348/E05.024

(57) ABSTRACT

To obtain a solid state imaging device having a data transfer function capable of outputting digital data after A/D conversion to the outside in a high speed.

Each of eight stage data blocks in a data bus part has a data line pair and an amplifier part which is coupled to the data line pair. Then, the amplifier part amplifies a signal of the data line pair on an amplifier data line pair to output the amplified signal as block data outputs at timing indicated by an amplifier enable signal and an amplifier control signal. Further, the eight stage data blocks are coupled with each other from the first stage to the last stage so that the preceding stage block data outputs may be provided to the following stage data line pair as block data inputs, respectively.

### CROSS-REFERENCE TO RELATED APPLICATION

The disclosure of Japanese Patent Application No. 2008-202728 filed on Aug. 6, 2008 including the specification, drawings and abstract is incorporated herein by reference in its entirety.

### TECHNICAL FIELD

This invention relates to a solid state imaging device such as a digital image sensor capable of realizing a high speed data output.

### BACKGROUND OF THE INVENTION

Hitherto, what is generally called a camera has been mainly a film type (silver halide type) camera (hereinafter, sometimes abbreviated as “film camera”), but recently a digital type camera (hereinafter, sometimes abbreviated as “digital camera”), which stores images as digital data, is replacing the film camera. The digital camera has been significantly improving image quality thereof, and a present situation is that the most advanced digital camera has realized a performance which exceeds that of the film camera. The digital cameras also includes a CCD image sensor type and a CMOS image sensor type, and the CMOS image sensor, which can easily mount a CMOS device, is attracting attention from a viewpoint of realizing a sophisticated camera.

FIG. 19 is an explanatory diagram showing an outline configuration of an analog image sensor. As shown in the drawing, an image (pixel) array 51 is mounted on a semiconductor chip 50 arranging pixels in a matrix, and column amplifiers 52a and 52b are disposed adjacent to the image array 51 on the top and the bottom sides in the drawing (on an extension line in the column direction) and a V-scanner 53 is disposed adjacent to the image array 51 on the left side in the drawing (on an extension line in the row direction). Pixel data on a row selected by the V-scanner 53 is divided and transferred to the column amplifiers 52a and 52b and amplified respectively by the column amplifiers 52a and 52b, and then the data is combined into a chip analog output COA to be output to an AFE (Analog Front End) 54. The AFE 54 outputs a digital output OD based on the chip analog output COA.

FIG. 20 is an explanatory diagram showing an outline configuration of a digital image sensor. As shown in the drawing, the image array 51 is mounted on the semiconductor chip 50 arranging the pixels in a matrix, and the column amplifiers 52a and 52b and column ADCs 55a and 55b are disposed adjacent to the image array 51 on the top and the bottom sides in the drawing and the V-scanner 53 is disposed adjacent to the image array 51 on the left side in the drawing. The pixel data on the row selected by the V-scanner 53 is divided and transferred to the column amplifiers 52a and 52b and amplified respectively by the column amplifiers 52a and 52b, and then the data is A/D-converted respectively by the column ADCs 55a and 55b. As a result, a chip digital output COD is obtained as a combination of the outputs from the column ADCs 55a and 55b.

The CMOS image sensor, which is one kind of a solid state imaging device, includes the analog image sensor shown in FIG. 19 and the digital image sensor shown in FIG. 20, and, although either one has an advantage and a disadvantage, the digital image sensor attracts attention from a view point of data processing speed. Specifically, by using the digital image sensor, it is possible not only to shoot a moving image but also to devise various applications using a combination with the following stage image processing. For example, when shooting a moment of a ball hitting a tennis racket or a face close-up of a child reaching the goal after running around a field in an athletic festival, just directing the camera in the direction thereof allows the camera to determine a shutter chance automatically and to press a shutter automatically. For realizing such processing, it is necessary to transfer a shot image instantly to an image processing IP (Intellectual Property), and to convert shooting information (analog) into image processing information (digital).

From such a background, already research and development have been made energetically for an analog/digital converter (ADC) intended for the camera. The most important problem in the CMOS image sensor is that a data processing amount becomes very large because the whole pixel information is to be converted into digital values. When only a single ADC simply performs the processing of ten million pixels at a typical video processing rate (30 fps (Frame Per Second)), for example, an image data processing part is required to carry out the A/D-conversion and data transfer of one-pixel information in three nanoseconds and this is unrealistic.

FIG. 21 is an explanatory diagram showing an example of a pixel data processing part 56 provided adjacent to the image array 51 (corresponding to the column amplifiers 52a and 52b and the column ADCs 55a and 55b in FIG. 20). As shown in the drawing, each of the two pixel data processing parts 56 provided adjacent to the image array 51 on the top and the bottom side in the drawing is configured with a plurality of pixel signal processing parts 66 (only pixel data processing part 56 on the bottom side is illustrated). The pixel signal processing parts 66 are provided at a rate of one to two pixels (one pixel corresponds to a pixel equivalent circuit 60), and each pixel signal processing part 66 is provided on a corresponding extension line in the column direction.

The pixel signal processing part 66 is configured with an amplifier part 67, an A/D converter 68, and a data latch/transfer part 69, and the amplifier part 67 receives and amplifies a pixel signal of the corresponding column, the A/D converter 68 A/D-converts the signal amplified by the amplifier part 67, and the data latch/transfer part 69 latches and transfers the data after the A/D conversion. The data transfer after the A/D conversion is performed between the data latch/transfer parts 69 in the pixel signal processing parts 66 using an output bus 57. Then, a (final) digital data output Dout is output sequentially from the last stage (right end in the drawing) data latch/transfer part 69 in the pixel signal processing part 66.

As shown in FIG. 21, the pixel equivalent circuit 60 is configured with a photodiode 61 and (NMOS) transistors 62 to 65, and a cathode of the photodiode 61, an anode of which is grounded, is coupled to a gate of the transistor 64 (node N60) via the transistor 62 and the transistor 63 is inserted between a power supply Vdd and the node N60. One electrode of the transistor 64 is coupled to the power supply Vdd and the other electrode is coupled to one electrode of the transistor 65, and then the other electrode of the transistor 65 serves as a photoelectric conversion signal output part. The gate electrodes of the transistors 62, 63, and 65 are provided with a control signal ΦT, a control signal ΦR, and a control signal ΦS, respectively.

The pixel equivalent circuit 60 with such a configuration, can obtain a potential determined according to a photoelectric conversion amount of the photodiode 61, using the control signal ΦT, the control signal ΦR, and the control signal ΦS, at the photoelectric conversion signal output part which is the other electrode of the transistor 65.

Specifically, the control signal ΦR is first made to exhibit “H” for charging the node N60 to have a voltage around that of the power supply Vdd, and then the control signal ΦR is made to exhibit a fall to “L” and the control signal ΦS is made to exhibit “H”. Subsequently, the control signal ΦT is made to exhibit “H” for providing the node N60 with a negative charge generated by the photoelectrical conversion of the photodiode 61. As a result, the potential of the node N60 decreases in proportion to the above negative charge amount, and an ON resistance of the transistor 64 increases according to the potential reduction extent of this node N60. Resultantly, the potential obtained at the other electrode of the transistor 65 is determined according to the ON resistance value of the transistor 64.

In the configuration shown in FIG. 21, it is possible to keep a size twice the pixel pitch for the horizontal width of the pixel signal processing part 66, by disposing the pixel signal processing parts 66 on the top and bottom side of the image (pixel) array 51. However, when the pixel configured with the above pixel equivalent circuit 60 has a pixel size of 5 μm per pixel, it is necessary to configure the pixel signal processing part 66 to have a horizontal width of 10 μm, twice the pixel size. Accordingly, one pixel signal processing part 66 among the pixel signal processing parts 66 composing the pixel data processing part 56 has to be configured in a very long and thin shape such as a horizontal width of 10 μm and a vertical width of 1 mm. Further it is necessary to design the A/D converter 68 within the pixel signal processing part 66 so as to satisfy this restriction. Such an assembly of the A/D converters 68 in the pixel data processing part 56 A/D-convert the pixel data of respective columns in the selected row and thereby the assembly is sometimes called “column ADC” in the present specification.

While the above column ADC has been developed energetically, there is not a satisfactory study of the data latch/transfer part 69 which outputs the digital data converted in the column ADC to the outside of the CMOS.

For example, conventional examples of the A/D convertor include one disclosed in Patent Document 1 (Japanese Unexamined Patent Application Publication No. 2005-303648 (FIG. 11 and FIG. 13)). Patent Document 1 shows a configuration example of an imaging element incorporating the column ADC, but discloses a data transfer part only abstractly by showing the data transfer part only with a horizontal signal line 18 illustrated as an arrow, as shown in FIG. 11 or FIG. 13.

Such disclosed contents supposedly comes from the understanding that satisfactory data transfer can be realized by a combination of existing techniques, because the high speed data transfer is not assumed in Patent document 1.

### SUMMARY OF THE INVENTION

### Problem to be Solved by the Invention

Considering a future progress trend of the digital camera, a high-speed data transfer circuit will be required inevitably for accommodating to a high-speed continuous shooting function.

However, there is a problem, as in above Patent document 1, that little technological devise has been achieved for transferring the digital data, which is stored in each column after the A/D conversion, to the input/output part in a high speed within the CMOS sensor having a large chip area.

This invention has been achieved for solving the above problem, and aims at obtaining a solid state imaging device which has a data transfer function capable of outputting the digital data after the A/D conversion to the outside in a high speed.

### Means for Solving the Problem

Each of data blocks having an eight stage configuration includes a data line pair and an amplifier part coupled to the data line pair, in a data bus part of a CMOS image sensor in the present embodiment. Then, the amplifier part amplifies a signal of the data line pair at timing indicated by an amplifier enable signal and an amplifier control signal and outputs the amplified signal as a block data output. Subsequently, the eight stage data blocks are coupled with each other from the first stage to the last stage so that the block data output of the preceding stage be provided to the following stage data line pair as a block data input.

According to the above feature, the present embodiment can obtain a potential difference which can be detected in a comparatively short time between the data line pair in each of the data blocks finely divided into eight stages, and thereby has an advantage of transferring the data in a high speed within the data bus part and outputting the data as the (last) data output to the outside in a high speed.

### BRIEF DESCRIPTION OF THE DRAWINGS

FIG. 1 is a block diagram illustrating an entire configuration of a CMOS image sensor which is a solid state imaging device according to an embodiment of this invention.

FIG. 2 is an explanatory diagram showing details of a digital output circuit shown in FIG. 1 and a peripheral part thereof.

FIG. 3 is an explanatory diagram showing details of a data bus part and a local counter part shown in FIG. 2.

FIG. 4 is an explanatory diagram showing an outline configuration of a 1-bit data bus part.

FIG. 5 is an explanatory diagram showing a detailed configuration of the data bus part shown in FIG. 4.

FIG. 6 is an explanatory diagram showing an internal configuration for one unit of data blocks in the data bus part shown in FIG. 5.

FIG. 7 is a circuit diagram showing an internal structure for one unit of latches shown in FIG. 6.

FIG. 8 is a circuit diagram showing an internal configuration of a D-flip-flop on the left side shown in FIG. 7.

FIG. 9 is a circuit diagram showing an internal configuration of a D-flip-flop on the right side shown in FIG. 7.

FIG. 10 is an explanatory diagram showing an internal configuration of a 1-bit local counter.

FIG. 11 is a circuit diagram showing an internal configuration of 256×1 bit local counter shown in FIG. 10 except for the first stage.

FIG. 12 is a circuit diagram showing an internal configuration of the first stage of 256×1 bit local counter shown in FIG. 10.

FIG. 13 is a circuit diagram showing an internal configuration for one of the D-flip-flops shown in FIG. 11.

FIG. 14 is a timing chart showing operation waveforms in one unit of data blocks.

FIG. 15 is a timing chart showing data transfer operation waveforms (1) in eight stage data blocks in a data bus part.

FIG. 16 is a timing chart showing data transfer operation waveforms (2) in eight stage data blocks in a data bus part.

FIG. 17 is a timing chart showing entire data transfer operation waveforms in eight stage data blocks in a data bus part.

FIG. 18 is a circuit diagram showing an internal configuration of another configuration example for the 256×1 bit local counter shown in FIG. 10.

FIG. 19 is an explanatory diagram showing an outline configuration of an analog image sensor.

FIG. 20 is an explanatory diagram showing an outline configuration of a digital image sensor.

FIG. 21 is an explanatory diagram showing an example of a pixel data processing part provided adjacent to an image array.

### DETAILED DESCRIPTION OF THE PREFERRED EMBODIMENTS

### Embodiment

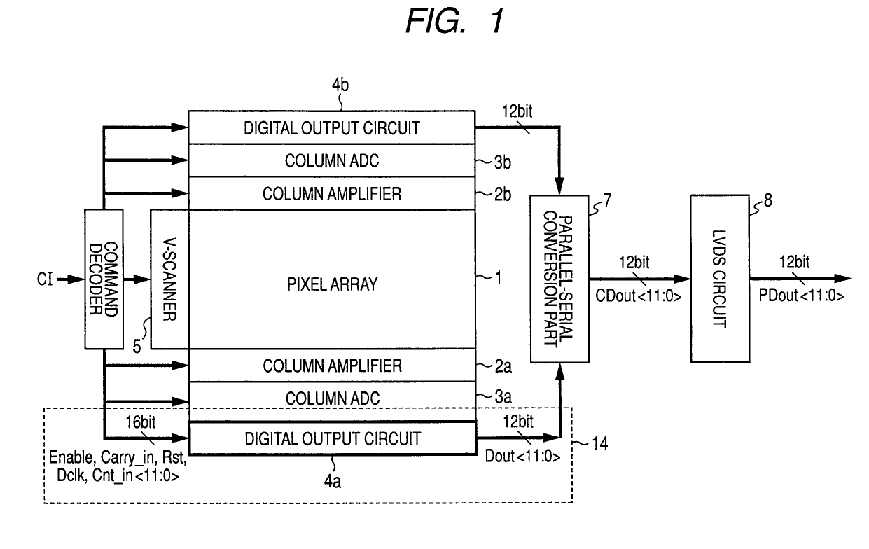

FIG. 1 is a block diagram showing an entire configuration of a CMOS image sensor which is a solid state imaging device according to an embodiment of this invention.

As shown in the drawing, column amplifiers 2a and 2b, column ADCs 3a and 3b, and digital output circuits 4a and 4b are disposed on the top side and the bottom side, in the drawing (on an extension line in the column direction), of a pixel array 1 which arranges pixels in a matrix. Then, a V-scanner 5 is disposed adjacent to the pixel array 1 on the left side in the drawing (on an extension line in the row direction). Note that the pixel array 1 has a pixel configuration of 4,096 (columns)×X (rows), and pixel signals (photoelectric conversion signals) for one row selected by the V-scanner 5 in the pixel array 1 are output to the column amplifiers 2a and 2b every other column. That is, 2,048 pixel signals are output to each of the column amplifiers 2a and 2b.

A command decoder 6 receives a command input CI and outputs control signals based on the command input CI to the column amplifiers 2a and 2b, the column ADCs 3a and 3b, the digital output circuits 4a and 4b, and the V-scanner 5. Note that the control signals to the digital output circuits 4a and 4b include an enable signal Enable, a carry-in signal Carry_in, a reset signal Rst, a data clock Dclk, and count inputs Cnt_in <11:0>, which will be described in the following.

The column amplifiers 2a and 2b respectively amplify the input 2,048 pixel signals and output the amplified pixel signals to the column ADCs 3a and 3b. The column ADCs 3a and 3b respectively A/D-convert the amplified pixel signals and output 2,048 (digital) pixel data (12-bit format) sets. The digital output circuits 4a and 4b respectively output the 2,048 pixel data sets sequentially to a parallel-serial conversion part 7 as 12-bit (final) data outputs Dout1 <11:0>.

The parallel-serial conversion part 7 selects two sets of the data outputs Dout <11:0> appropriately and output a 12-bit conversion data outputs CDout <11:0> to an LVDS (Low Voltage Differential Signaling) circuit 8. The LVDS circuit 8 converts the conversion data outputs CDout <11:0> into pixel data outputs PDout <11:0> which is compliant to a signal standard and outputs the converted pixel data outputs PDout <11:0>.

A feature of the present invention in the CMOS image sensor of the embodiment exists in a part of the digital output circuits 4a and 4b. Accordingly, the constituents other than the digital output circuits 4a and 4b can be realized by an existing technique or the like. The above described pixel array 1, column amplifiers 2a and 2b, and column ADCs 3a and 3b function as a pixel array part outputting the pixel data sets in a lump after the A/D conversion.

Here, since the configuration and the operation are common between the digital output circuits 4a and 4b, the digital output circuit 4a and a peripheral part thereof within the digital output circuit part and the peripheral part thereof 14 which is enclosed by a broken line will be mainly described below.

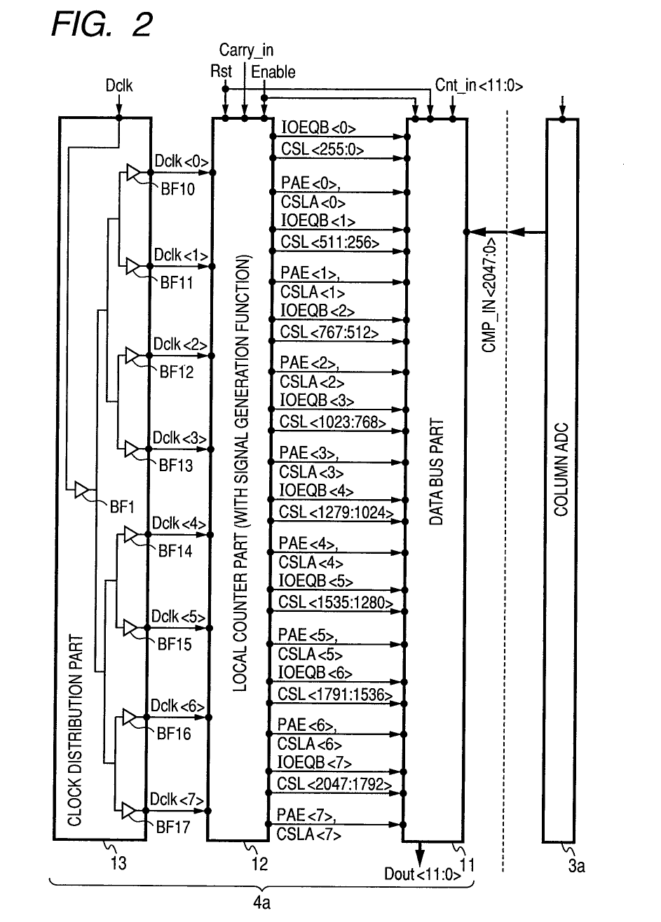

FIG. 2 is an explanatory diagram showing details of the digital output circuit part and the peripheral part thereof 14 shown in FIG. 1. As shown in the drawing, the column ADC 3a outputs 2,048-bit AD conversion comparison results CMP_in <2047:0>. Note that the AD conversion comparison results CMP_in <2047:0> have a property that timing of a fall to “L” becomes more delayed as the corresponding pixel becomes brighter.

The digital output circuit 4a is configured with a data bus part 11, a local counter part 12, and a clock distribution part 13.

The data bus part 11 receives the count inputs Cnt_in <11:0>, the enable signal Enable, and the reset signal Rst from the command decoder 6, and sequentially outputs the 2,048 12-bit data outputs Dout <11:0> which are obtained from the AD conversion comparison results CMP_in <2047:0>, under control of the local counter part 12.

The local counter part 12 (timing control signal generation part) having a timing control signal generation function receives the enable signal Enable, the carry-in signal Carry_in, and the reset signal Rst from the command decoder 6, and carries out a count operation according to digital clocks Dclk <0> to Dclk <7> obtained from the clock distribution part 13, for outputting various timing control signals to the data bus part 11.

Note that the control signals provided to the data bus part 11 from the local counter part 12 include equalization signals IOEQB <7:0>, column selection signals CSL <2047:0>, amplifier enable outputs PAE <7:0>, and amplifier control signals CSLA <7:0>. Here, “A <β:a>” means A <a> to A <β> in the present specification.

The clock distribution part 13 receives the data clock Dclk which is a reference clock CLKK of the command decoder 6, provides an output of a buffer BF1, which receives the data clock Dclk, to the buffers BF10 to BF17 by distributing the output with eight equal-length wirings, and outputs the digital clocks Dclk <0> to Dclk <7> from the respective buffers BF10 to BF17.

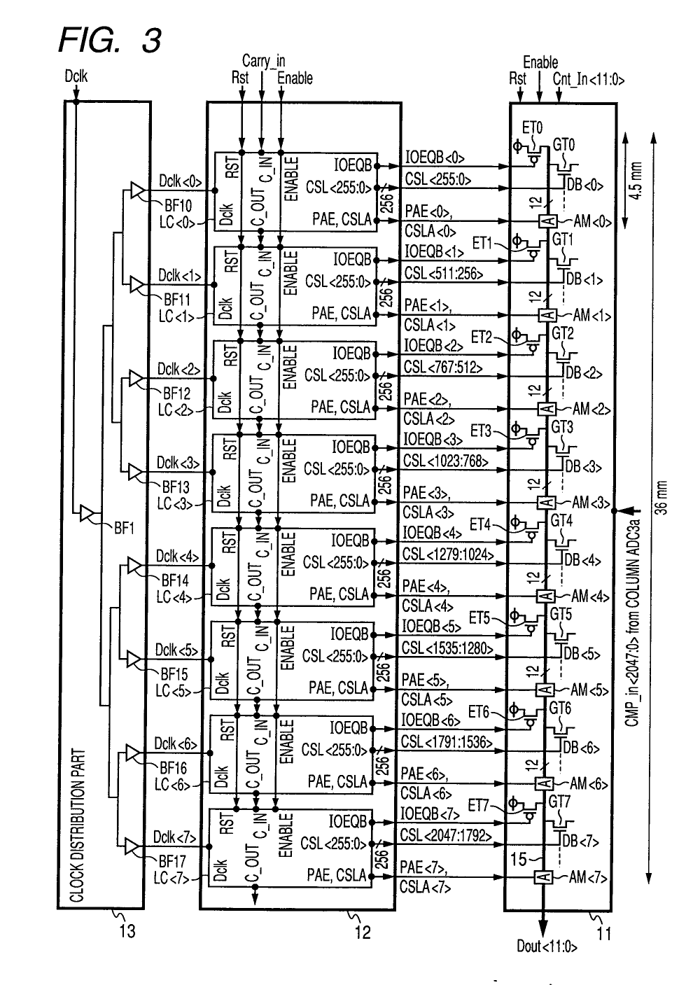

FIG. 3 is an explanatory diagram showing details of the data bus part 11 and the local counter part 12 shown in FIG. 2. As shown in the drawing, the local counter part 12 is configured with eight (predetermined number) local counters LC <0> to LC <7>.

The local counter LC <0> receives the digital clock Dclk <0> at a clock input part (Dclk), also receives the carry-in signal Carry_in as a transfer input signal C_IN, and outputs a transfer output signal C_OUT. Further, the local counter LC <0> receives the enable signal Enable and the reset signal Rst at an enable input ENABLE and a reset input RST, respectively.

Then, the local counter LC <0> outputs the equalization output IOEQB as an equalization output IOEQB <0>, and outputs the (local) column selection signals CSL <255:0> of 256 bits×12 bits as column selection signals CSL <255:0>. Further, the local counter LC <0> outputs the amplifier enable output PAE and the amplifier control signal CSLA as the amplifier enable signal PAE <0> and the amplifier control signal CSLA <0>, respectively.

The local counter LC <1> receives the digital clock Dclk <1> at a clock input part (Dclk), also receives the transfer output signal C_OUT of the local counter LC <0> as the transfer input signal C_IN, and outputs the transfer output signal C_OUT. Further, the local counter LC <1> receives the enable signal Enable and the reset signal Rst at an enable input ENABLE and a reset input RST, respectively.

Then, the local counter LC <1> outputs the equalization output IOEQB as the equalization output IOEQB <1>, and outputs the (local) column selection signals CSL <255:0> as the column selection signals CSL <511:256>. Further, the local counter LC <1> outputs the amplifier enable output PAE and the amplifier control signal CSLA as the amplifier enable signal PAE <1> and the amplifier control signal CSLA <1>, respectively.

Similarly, the local counters LC <2>˜<7> receive the digital clocks Dclk <2>˜<7>, also receive the transfer output signals C_OUT of the local counters LC <1>˜<6> as the transfer input signals C_IN, and output the transfer output signals C_OUT, respectively. Further, the local counters LC <2>˜<7> commonly receive the enable signal Enable and the reset signal Rst at enable inputs ENABLE and reset inputs RST, respectively.

Then, the local counters LC <2>˜<7> output the equalization outputs IOEQB as the equalization output IOEQB <2>˜<7> and output the (local) column selection signals CSL <255:0> as the column selection signals CSL <767:512>, <1023:768>, <1279:1024>, <1535:1280>, <1791:1536> and <2047:1792>. Further, the local counters LC <2>˜<7> output the amplifier enable outputs PAE and the amplifier control signals CSLA as the amplifier enable signals PAE <2>˜<7> and the amplifier control signals CSLA <2>˜<7>, respectively.

The data bus part 11 is configured with eight (predetermined number) data blocks DB <0>˜<7> and a data transfer bus 15. Each of the data blocks DB <i> (i=0˜7) is configured with an equalization transistor ETi, a gate transistor GTi, and an amplifier part AM <i>. Here, each of the gate transistors GTi, while having a configuration of 256×12 bits, is illustrated by one representing transistor for convenience.

Specifically, the amplifier parts AM <0> to AM <7> are inserted so as to divide the data transfer bus 15 into eight divisions. Then, the PMOS equalization transistor ETi has one electrode coupled to a power supply Vdd and the other electrode coupled to the data transfer bus 15, and receives the equalization output IOEQB <i> at the gate electrode thereof. The gate transistor GTi has one electrode coupled to any one of the AD conversion comparison results CMP_in <2047:0> and the other electrode coupled to the data transfer bus 15, and receives the column selection signals CSL <255+256·i:256·> at a gate electrode thereof.

The amplifier part AM <i> amplifies the pixel data after the A/D conversion which is read out via the gate transistor GTi, and transfers the amplified pixel data appropriately to the data transfer bus 15 coupled to the following stage amplifier part AM <i+1> under timing control of the amplifier enable signal PAE <i> and the amplifier control signal CSLA <i>. Then, finally the amplifier part AM <7> sequentially outputs the 12-bit data outputs Dout <11:0>.

In this manner, the data bus part 11 transfers the data of 2,048 columns×12 bits via the 12-bit-bus width data transfer bus 15 which is divided into eight blocks, using eight stages of the data block DB <i> for 256 columns (4.5 mm).

Then, corresponding to the 8-stage data blocks DB <0> to DB <7>, the local counters LC <0> to LC <7> are disposed respectively having almost the same configuration. Further, the digital clock Dclk <i> driving each of the local counters LC <i> is set so as to make timing skew smaller using the equal-length wiring clock tree in the clock distribution part 13.

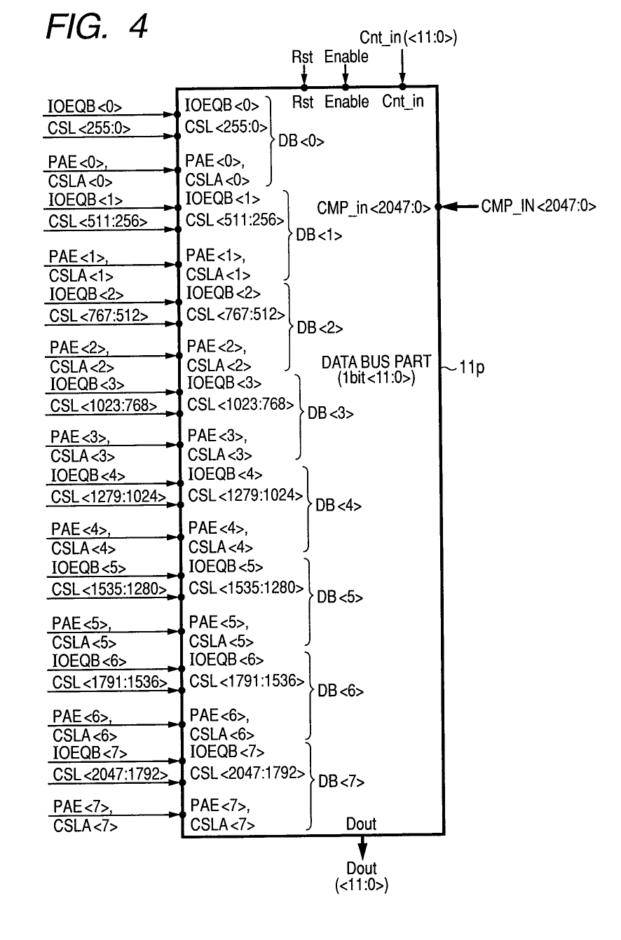

FIG. 4 is an explanatory diagram showing an outline configuration of the 1-bit data bus part 11p. As shown in the drawing, the data bus part 11p receives corresponding one bit of the count inputs Cnt_in <11:0> from the command decoder 6 as the count input Cnt_in, and also receives the enable signal Enable and the reset signal Rst. Then, the data bus part 11p sequentially outputs the 2,048 corresponding 1-bit data outputs Dout obtained from the AD conversion comparison results CMP_in <2047:0> under timing control of the local counter part 12 which is not shown in the drawing.

The data bus part 11p receives the equalization signals IOEQB <7:0>, the column selection signals CSL <2047:0>, the amplifier enable outputs PAE <7:0>, and the amplifier control signals CSLA <7;0>, as the timing control signals from the local counter part 12 which is not shown in the drawing.

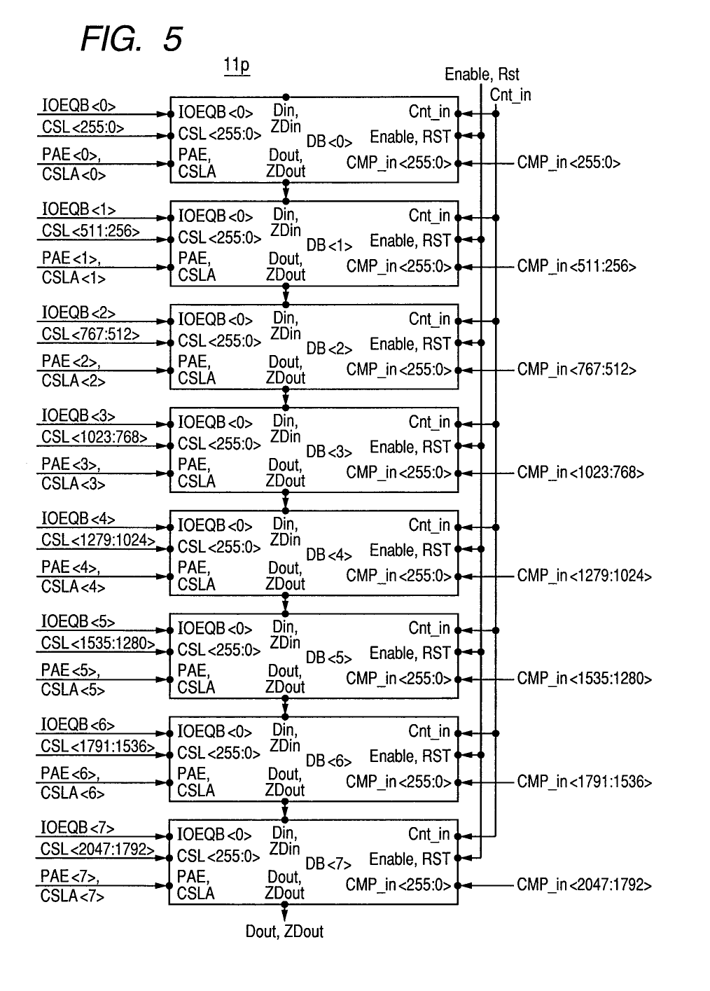

FIG. 5 is an explanatory diagram showing a detailed configuration of the data bus part 11p. As shown in the drawing, the data bus part 11p is configured with the data blocks DB <0> to DB <7>.

As shown in the drawing, the AD conversion comparison results CMP_in <2047:0>, which are the plurality of pixel data sets after the A/D conversion, are divided into eight divided pixel data groups (CMP_in <255:0>. <511:256>, <767:512>, <1023:768>, <1279:1024>, <1535:1280>, <1791:1536> and <2047:1792>). Then, the data blocks DB <0> to DB <7> take in the corresponding above eight divided pixel data groups.

Further, the transfer output signal C_OUT of the preceding stage is provided to the following stage as the transfer input signal C_IN among the data blocks DB <0> to DB <7>.

The data block DB <0> receives the equalization output IOEQB <0>, the column selection signals CSL <255:0>, the amplifier enable signal PAE <0>, and the amplifier control signal CSLA <0>, from the local counter part 12 which is not shown in the drawing.

Further, the data block <0> receives the enable signal Enable, the reset signal Rst, and the count input Cnt_in from the command decoder 6 which is not shown in the drawing, and also receives the AD conversion comparison results CMP_in <255:0> from the column ADC 3a which is not shown in the drawing.

The data block DB <1> receives the equalization output IOEQB <1>, the column selection signals CSL <512:256>, the amplifier enable signal PAE <1>, and the amplifier control signal CSLA <1>, from the local counter part 12 which is not shown in the drawing.

Further, the data block DB <1> receives the enable signal Enable, the reset signal Rst, and the count input Cnt_in from the command decoder 6 which is not shown in the drawing, and also receives the AD conversion comparison results CMP_in <511:256> from the column ADC 3a which is not shown in the drawing.

Similarly, the data block DB <j> (j=2 to 7) receives the equalization output IOEQB <j>, the column selection signals CSL <(255+256·j):(256·j)>, the amplifier enable signal PAE <j>, and the amplifier control signal CSLA <j>, from the local counter part 12 which is not shown in the drawing.

Further, the data block DB <j> receives the enable signal Enable, the reset signal Rst, and the count input Cnt_in from the command decoder 6 which is not shown in the drawing, and also receives the AD conversion comparison results CMP_in <(255+256·j):(256·j)> from the column ADC 3a which is not shown in the drawing.

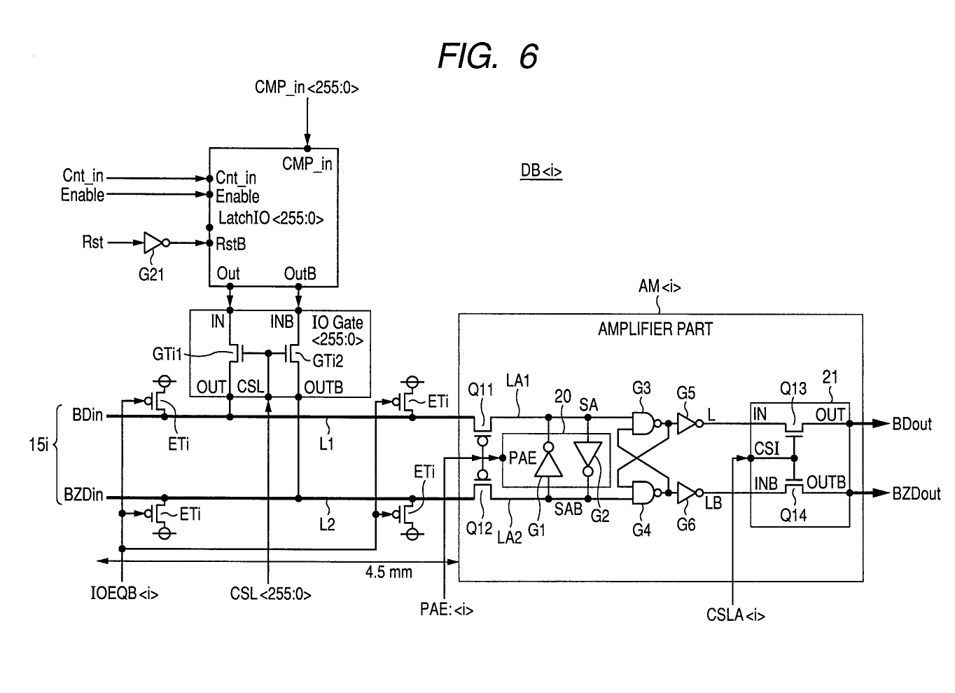

FIG. 6 is an explanatory diagram showing an internal configuration of the data block DB <i> in the data bus part 11p. The data transfer bus 15i, which is a division of the data transfer bus 15 for the data block DB <i>, is composed of a data line pair L1 and L2. The both ends of the data line L1 are coupled with the other side electrodes of equalization transistors ETi, respectively, and the both ends of the data line L2 are coupled with the other side electrodes of the other equalization transistors ETi, respectively. The electrodes on one side of these equalization transistors ETi are commonly coupled to the power supply Vdd, and gate electrodes are commonly provided with the equalization output IOEQB <i>.

256 input/output gates IOGate <255:0> and latches LatchIO <255:0> are provided corresponding to the column selection signals CSL <255:0> (only one representative is shown for each thereof in FIG. 6).

Each of the input/output gates IOGate <255:0> is configured with a pair of gate transistors GTi1 and GTi2, and one electrode of the gate transistor GTi1 (IN side) is coupled to a first output part OUT of the latches LatchIO <255:0> and the other electrode (OUT side) is coupled to the data line L1. One electrode (INB side) of the gate transistor GTi2 is coupled to a second output part OutB of the latches LatchIO <255:0> and the other electrode (OUTB side) is coupled to the data line L2. Gate electrodes of the gate transistors GTi1 and GTi2 are commonly provided with a corresponding signal among the column selection signals CSL <255:0>.

The latches LatchIO <255:0> input an inverted reset signal RstB obtained from the reset signal Rst via an inverter G21 and further input the count input Cnt_in and the enable signal Enable, and then receives the corresponding AD conversion comparison result CMP_in among the AD conversion comparison results CMP_in <255:0>.

The amplifier part AM <i> amplifies a potential difference between amplifier data line pair LA1 and LA2, and outputs block data outputs BDout and BZDout based on the amplified result to the data line pair L1 and L2 of the data transfer bus 15 (i+1) in the following stage data block DB <i+1> as block data inputs BDin and BZDin, respectively.

The amplifier data line LA1 is coupled to the data line L1 via a PMOS connection transistor Q11, and the amplifier data line LA2 is coupled to the data line L2 via a PMOS connection transistor Q12. Gate electrodes of the connection transistors Q11 and Q12 are provided with the amplifier enable signal PAE <i>.

An amplifier part 20 which is configured with invertors G1 and G2 is provided between the amplifier data line pair LA1 and LA2 and amplifies the potential difference between the amplifier data line pair LA1 and LA2 to amplify one potential to “H” and the other potential to “L”, by alternately coupling the invertors G1 and G2 between the amplifier data line pair LA1 and LA2.

One input of a NAND gate G3 is coupled to the amplifier data line LA1, one input of a NAND gate G4 is coupled to the amplifier data line LA2, and an output of the NAND gate G3 is coupled to an input of an inverter G5 and the other input of the NAND gate G4. Further, an output of the NAND gate G4 is coupled to an input of an inverter G6 and the other input of the NAND gate G3.

An output gate part 21 is configured with NMOS connection transistors Q13 and Q14, and one electrode of the connection transistor Q13 receives an output L of the inverter G5, and a signal obtained from the other electrode of the connection transistor Q13 becomes the block data output BDout. One electrode of the connection transistor Q14 receives an output LB of the inverter G6, and a signal obtained from the other electrode of the connection transistor Q14 becomes the block data output BZDout. Then, gate electrodes of the connection transistors Q13 and Q14 are commonly provided with the amplifier control signal CSLA <i>.

The wiring length of the data transfer bus 15i in each of the data blocks DB <i> is set to be approximately 4.5 mm. Note that while the amplifier part AM <i> is shown to be disposed on an extension line of the data transfer bus 15i for convenience of illustration, the amplifier part AM <i> is provided on the upper side or the lower side, in the drawing, of the data transfer bus 15i for formation so as to be contained within the wiring length of the data transfer bus 15i similar to the input/output gates IOGate <255:0> and the latches LatchIO <255:0>. Accordingly, a horizontal width of the data block DB <i> can be formed to approximately 4.5 mm which is the wiring length of the data transfer bus 15i.

The data block DB <i> having such an configuration inputs the column selection signals CSL <255:0> to the input/output gates IOGate <255:0>, respectively, for controlling open/close (ON/OFF) thereof. Among the 256 column selection signals CSL <255:0>, only one selected signal is activated to exhibit an “H” state, and latch data of the latch LatchIO <s> corresponding to the activated CSL <s> (s=any of 0 to 255) is selectively read out to the data line pair L1 and L2 via the IOGate <s>.

The data transferred to the data line pair L1 and L2 is amplified by the amplifier part AM <i> and transferred to the data line pair L1 and L2 of the following stage (one on the right side) data block DB <i+1> in the next cycle.

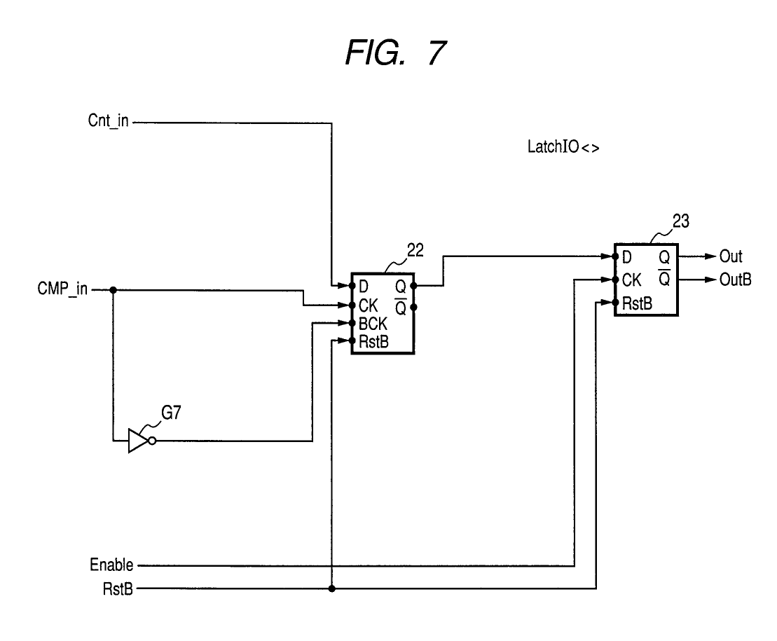

FIG. 7 is a circuit diagram showing an internal structure of the latch LatchIO < > (one of the 256 latches LatchIO <255:0>). As shown in the drawing, the latch LatchIO < > is configured with D-flip-flops 22 and 23 and an inverter G7.

The D-flip-flop 22 receives the count input Cnt_in at a D-input, also receives the AD conversion comparison result CMP_in at a clock input CK, further receives a signal obtained from the AD conversion comparison result CMP_in via the inverter G7 at an inverted clock input BCK, and inputs an inverted reset signal RstB into an inverted reset input part RstB.

The D-flip-flop 23 is coupled with a Q output of the D-flip-flop 22 at a D-input, receives the enable signal Enable at a clock input CK, and inputs the inverted reset signal RstB into an inverted reset input part RstB.

Then, a Q-output of the D-flip-flop 23 becomes a first output part Out, and an inverted Q-output Bar-Q becomes a second output part OutB.

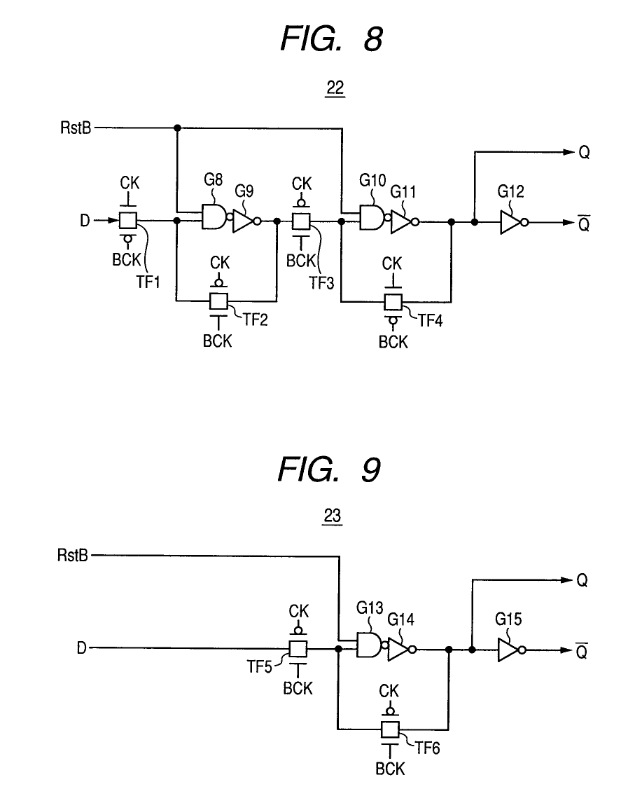

FIG. 8 is a circuit diagram showing an internal configuration of the D-flip-flop 22 shown in FIG. 7. As shown in the drawing, the D-flip-flop 22 is configured with NAND gates G8 and G10, inverters G9, G11 and G12, and transfer gates TF1 to TF 4.

The NAND gate G8 receives the inverted reset signal RstB at one input and also receives a signal obtained from the D-input via the transfer gate TF1 at the other input. An output of this NAND gate G8 is coupled to an input of the inverter G9, and an output of the inverter G9 returns to the other input of the NAND gate G8 via the transfer gate TF2.

The NAND gate G10 receives the inverted reset signal RstB at one input, and the other input is coupled with the output of the inverter G9 via the transfer gate TF3. An output of this NAND gate G10 is connected to an input of the inverter G11, and an output of the inverter G11 returns to the other input of the NAND gate G10 via the transfer gate TF4.

An output of the inverter G11 is coupled to an input of the inverter G12. Then, an output of the inverter G11 becomes a Q-output and an output of the inverter G12 becomes an inverted Q-output Bar-Q.

Further, NMOS gates of the transfer gates TF1 and TF4 are provided with the clock input CK, and PMOS gates are provided with the inverted clock input BCK. On the other hand, NMOS gates of the transfer gates TF2 and TF3 are provided with the inverted clock input BCK, and PMOS gates are provided with the clock input CK.

The D-flip-flop 22 having such a configuration initializes the Q-output to “L” (inverted Q-output Bar-Q to “H”) when reset (inverted reset signal RstB=“L”), and stores data input into the D-input immediately before a trigger of a fall to “L” (rise to “H”) in the clock input CK (inverted clock input BCK) and holds the data as the Q-output (inverted Q-output Bar-Q).

FIG. 9 is a circuit diagram showing an internal configuration of the D-flip-flop 23 shown in FIG. 7. As shown in the drawing, the D-flip-flop 23 is configured with a NAND gate G13, inverters G14 and G15, and transfer gates TF5 and TF6.

The NAND gate G13 receives the inverted reset signal RstB at one input and also receives a signal obtained from the D-input via the transfer gate TF5 at the other input. An output of this NAND gate G13 is coupled to an input of the inverter G14, and an output of the inverter G14 returns to the other input of the NAND gate G13 via the transfer gate TF6.

An output of the inverter G14 is coupled to an input of the inverter G15. Then, an output of the inverter G14 becomes the Q-output and an output of the inverter G15 becomes the inverted Q-output Bar-Q.

Further, an NMOS gate of the transfer gate TF5 is provided with the clock input CK, and a PMOS gate thereof is provided with the inverted clock input BCK. On the other hand, an NMOS gate of the transfer gate TF6 is provided with the inverted clock input BCK, and a PMOS gate thereof is provided with the clock input CK.

The D-flip-flop 23 having such a configuration initializes the Q-output to “L” (inverted Q-output Bar-Q to “H”) when reset (inverted reset signal RstB=“L”), and outputs data input into the D-input when the clock input CK (inverted clock input BCK) is “H” (“L”) as the Q-output (inverted Q-output Bar-Q).

The following will describe operation of the latch LatchIO < > shown in FIG. 7 to FIG. 9. As described above, the AD conversion comparison result CMP_in input into the latch LatchIO < > has the property that the timing of the fall to “L” is delayed according to the brightness of the corresponding pixel.

Meanwhile, the count input Cnt_in has a 12-bit length and is counted up along with elapsed time. Accordingly, the latch LatchIO < > latches the value of the count input Cnt_in immediately before the AD conversion comparison result CMP_in falls to “L”, and 12-bit latch data according to the AD conversion comparison result CMP_in is held in the latch LatchIO < >.

Note that, while FIG. 7 shows the latch LatchIO < > in a form corresponding to the 1-bit count input Cnt_in and AD conversion comparison result CMP_in for convenience, actually 12 sets of the configurations shown in FIG. 7 are provided in parallel to have a 12-bit configuration for corresponding to the count input Cnt_in <11:0>.

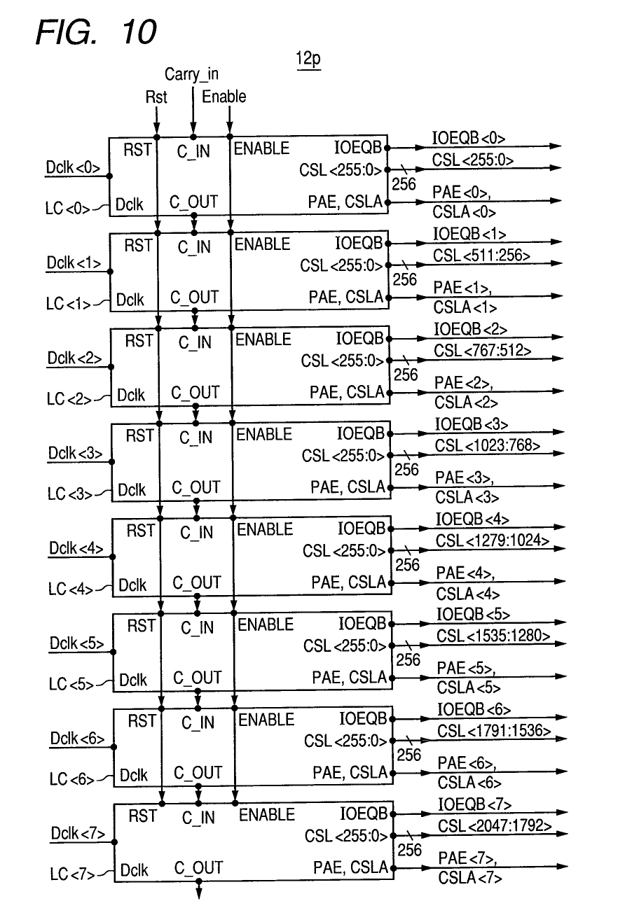

FIG. 10 is an explanatory diagram showing an internal configuration of the local counter part 12p having 1-bit configuration. As shown in the drawing, the local counter part 12p is configured with eight local counters LC <0> to LC <7>. The configuration of each local counter LC <i> (i 0˜7) is the same as that of the local counter part 12 shown in FIG. 3 except for that the (local) column selection signals CSL <255:0> have a 256×1 bit format. Accordingly, detailed description will be omitted.

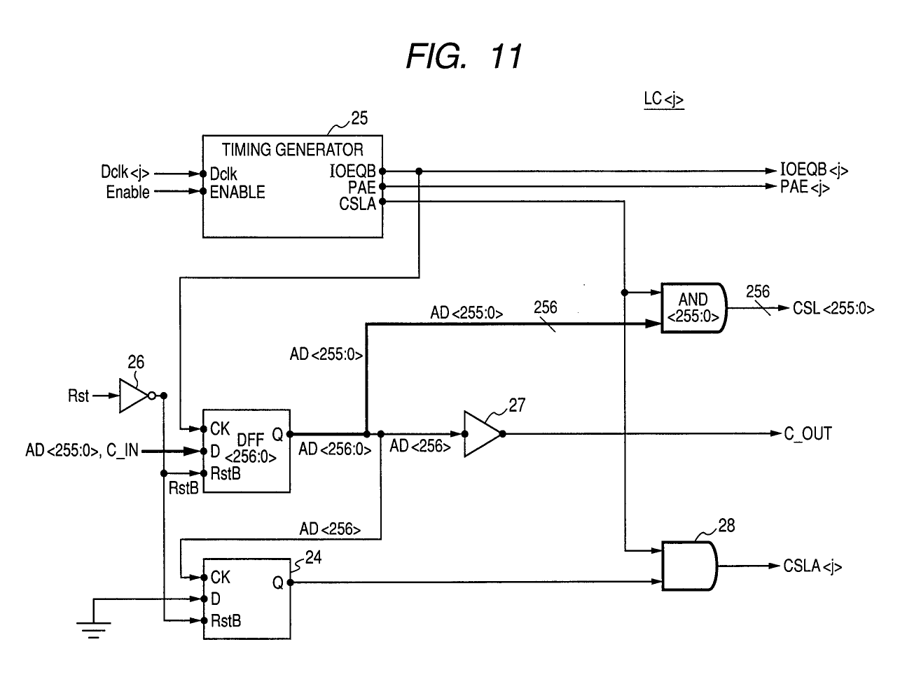

FIG. 11 is a circuit diagram showing an internal configuration of the local counter LC <j> (any of J=1-7) having 256×1 bit configuration shown in FIG. 10.

As shown in the drawing, the local counter LC <j> is configured with a timing generator 25, 257 D-flip-flops DFF <256:0>, a D-flip-flop 24, an inverter 26, a buffer 27, an AND gate 28, and 256 AND gates AND <255:0>.

The timing generator 25 receives the data clock Dclk <j> and the enable signal Enable to have an active state when the enable signal Enable exhibits “H”, and outputs the equalization output IOEQB <j>, the amplifier enable output PAE <j>, and the amplifier control signal CSLA. The equalization output IOEQB, the amplifier enable output PAE <j>, and the amplifier control signal CSLA switch “H” and “L” at a predetermined timing in synchronization with the data clock Dclk <j>.

The D-flip-flop DFF <0> receives the equalization output IOEQB at a clock input CK, also receives the transfer output signal C_OUT of the preceding stage local counter LC <j−1> at a D-input as the transfer input signal C_IN, and further receives the inverted reset signal RstB obtained from the reset signal Rst via the inverter 26 at an inverted reset input RstB. Then, a Q-output of the D-flip-flop DFF <0> (digital output AD <0>) is provided to a D-input of the following stage D-flip-flop DFF <1>.

The D-flip-flop DFF <k> (k=1˜255) receives the equalization output IOEQB at a clock input CK, also receives a Q-output of the D-flip-flop DFF <k−1> (digital output AD <k−1>) at a D-input, and further receives the inverted reset signal RstB at an inverted reset input RstB. Then, a Q-output of the D-flip-flop DFF <k> (digital output AD <k>) is provided to a D-input of the following stage D-flip-flop DFF <k+1>.

The D-flip-flop DFF <256> receives the equalization output IOEQB at a clock input CK, also receives a Q-output of the D-flip-flop DFF <255> (digital output AD <255>) at a D-input, and further receives the inverted reset signal RstB at an inverted reset input RstB. Then, a Q-output of the D-flip-flop DFF <256> (digital output AD <256>) is provided to the clock input CK of the D-flip-flop 24.

In this manner, each of the D-flip-flops DFF <256:0> sequentially transfers “H” obtained from the transfer input signal C_IN transferred from the preceding stage D-flip-flop in synchronization with the equalization output IOEQB. Accordingly, any only one of the digital outputs AD <256:0> becomes “H” (“1”).

Note that FIG. 11 shows the 257 D-flip-flops DFF <0> to DFF <256> in a lump as the D-flip-flops DFF <256:0> for convenience.

The D-flip-flop 24 receives the digital output AD <256> at a clock input CK, fixes a D-input to the ground level, and receives the inverted reset signal RstB at an inverted reset input RstB.

The 256 AND gates AND <255:0> commonly receive the amplifier control signal CSLA at one side inputs and receives the corresponding digital outputs AD <255:0> at the other side inputs, and output the respective 256 column selection signals CSL <255:0> which are logical products of the one side inputs and the other side inputs, respectively.

Note that FIG. 11 shows the 256 AND gates AND <0> to AND <255> in a lump as the AND gates AND <255:0> for convenience.

The digital output AD <256> which is the Q-output of the D-flip-flop DFF <256> is output via the buffer 27 as the transfer output signal C_OUT.

The AND gate 28 receives the amplifier control signal CSLA at one input, receives a Q-output of the D-flip-flop 24 at the other input, and outputs the amplifier control signal CSLA <j>.

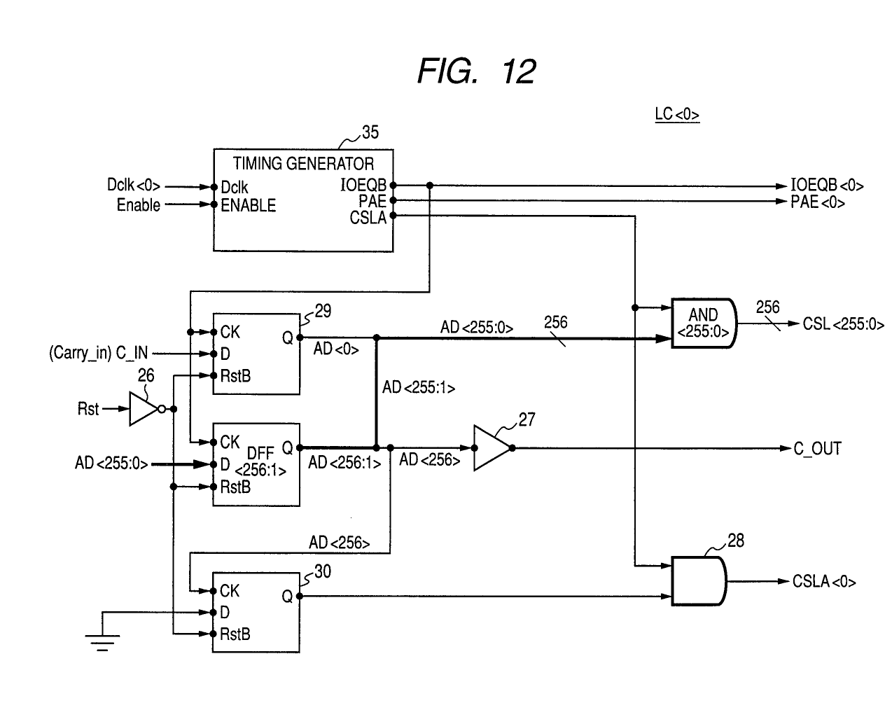

FIG. 12 is a circuit diagram showing an internal configuration of the local counter LC <0> having the 256×1 bit configuration shown in FIG. 10.

As shown in the drawing, the local counter LC <0> is configured with a timing generator 35, 256 D-flip-flops DFF <256:1>, a D-flip-flop 29, a D-flip-flop 30, an inverter 26, a buffer 27, an AND gate 28, and 256 AND gates AND <255:0>.

The timing generator 35 receives the data clock Dclk <0> and the enable signal Enable to have an active state when the enable signal Enable exhibits “H”, and outputs the equalization output IOEQB <0>, the amplifier enable output PAE <0>, and the amplifier control signal CSLA. The equalization output IOEQB, the amplifier enable output PAE <0>, and the amplifier control signal CSLA switch “H” and “L” at a predetermined timing in synchronization with the data clock Dclk <0>.

The D-flip-flop 29 receives the equalization output IOEQB at a clock input CK, also receives the transfer input signal C_IN (carry-in signal Carry_in) at a D-input and further receives the inverted reset signal RstB obtained from the reset signal Rst via the inverter 26 at an inverted reset input RstB. Then, a Q-output of the D-flip-flop 29 (digital output AD <0>) is provided to a D-input of the following stage D-flip-flop DFF <1>.

The D-flip-flop DFF <k> (k=1˜255) receives the equalization output IOEQB at a clock input CK, also receives a Q-output of the D-flip-flop DFF <k−1> (AD <k−1>) at a D-input, and further receives the inverted reset signal RstB at an inverted reset input RstB. Then, a Q-output of the D-flip-flop DFF <k> (digital output AD <k>) is provided to a D-input of the following stage D-flip-flop DFF <k+1>.

The D-flip-flop DFF <256> receives the equalization output IOEQB at a clock input CK, also receives a Q-output of the D-flip-flop DFF <255> (AD <255>) at a D-input, and further receives the inverted reset signal RstB at an inverted reset input RstB. Then, a Q-output of the D-flip-flop DFF <256> (digital output AD <256>) is provided to a clock input CK of the following stage D-flip-flop 30.

In this manner, the D-flip-flop 29 and the D-flip-flops DFF <256:1> sequentially transfer “H” set when the D-flip-flop 29 is reset in synchronization with the equalization output IOEQB. Accordingly, any only one of the digital outputs AD <256:0> becomes “H” (“1”). Note that the carry-in signal Carry_in is a fixed signal of “L” as described below.

Note that FIG. 12 shows the 256 D-flip-flops DFF <1> to DFF <256> in a lump as the D-flip-flop DFF <256:1> for convenience.

The D-flip-flop 30 receives the digital output AD <256> at a clock input CK, fixes a D-input to the ground level, and receives the inverted reset signal RstB at an inverted reset input RstB.

The 256 AND gates AND <255:0> commonly receive the amplifier control signal CSLA at one side inputs and receives the corresponding digital outputs AD <255:0> at the other side inputs, and output the respective 256 column selection signals CSL <255:0> which are logical products of the one side inputs and the other side inputs, respectively.

Note that FIG. 12 shows the 256 AND gates AND <0> to AND <255> in a lump as the AND gates AND <255:0> for convenience.

The digital output AD <256> which is the Q-output of the D-flip-flop DFF <256> is output via the buffer 27 as the transfer output signal C_OUT.

The AND gate 28 receives the amplifier control signal CSLA at one input, receives a Q-output of the D-flip-flop 30 at the other input, and outputs the amplifier control signal CSLA <0>.

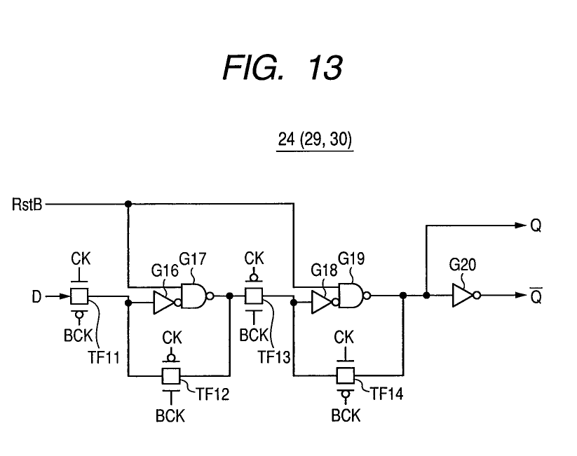

FIG. 13 is a circuit diagram showing an internal configuration of the D-flip-flop 24 shown in FIG. 11. As shown in the drawing, the D-flip-flop 24 is configured with NAND gates G17 and G19, inverters G16, G18 and G20, and transfer gates TF11 to TF14.

The NAND gate G17 receives the inverted reset signal RstB at one input and received an output of the inverter G16 at the other input. The inverter G16 receives a signal obtained from the D-input via the transfer gate TF11 at an input part. An output of the NAND gate G17 returns to the input of the inverter G16 via the transfer gate TF12.

The NAND gate 19 receives the inverted reset signal RstB at one input and receives an output of the inverter 18 at the other input. An input part of the inverter G18 is coupled with the output of the NAND gate G17 via the transfer gate TF13. An output of the NAND gate G19 returns to the input of the inverter G18 via the transfer gate TF14.

The output of the NAND gate G19 is coupled to an input of the inverter G20. Then, the output of the NAND gate G19 becomes the Q-output and an output of the inverter G20 becomes an inverted Q-output Bar-Q.

Further, NMOS gates of the transfer gates TF11 and TF14 are provided with the clock input CK and PMOS gates thereof are provided with the inverted clock input BCK. On the other hand, NMOS gates of the transfer gates TF12 and TF13 are provided with the inverted clock input BCK and PMOS gates thereof are provided with the clock input CK.

The D-flip-flop 24 having such a configuration initializes the Q-output to “H” (inverted Q-output Bar-Q to “L”) when reset (invertedreset signal RstB=“L”), and stores data input immediately before a trigger of a fall to “L” in the clock input CK (inverted clock input BCK) to hold the data as the Q-output (inverted Q-output Bar-Q).

Note that each of the D-flip-flops 29 and 30 shown in FIG. 12 has the same internal configuration as that of the D-flip-flop 24. On the other hand, D-flip-flops DFF <256:0> shown in FIG. 11 and FIG. 12 have internal configurations similar to that of the D-flip-flop 22 shown in FIG. 8.

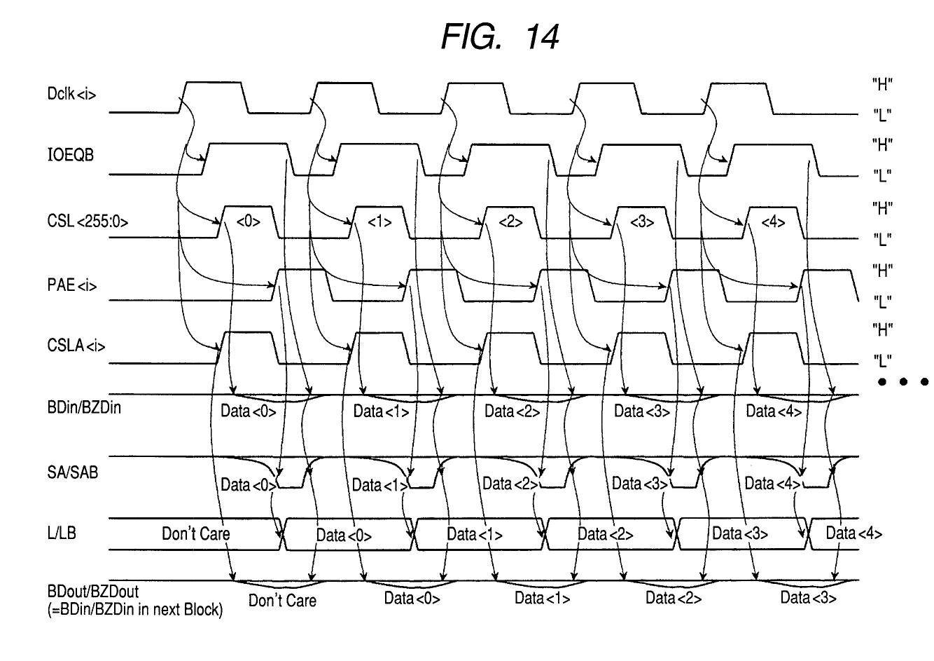

FIG. 14 is a timing chart showing operation waveforms in one unit of the data blocks DB <i>. The following will describe operation of the data block DB <i> shown in FIG. 6.

“H” and “L” exhibited by the equalization output IOEQB and the amplifier control signal CSLA <i> are changed in synchronization with the digital clock Dclk <i>. Then, in each of the column selection signals CSL <255:0>, an “H” period appears in the order of the column selection signals CSL <0>, CSL <1>, CSL <2>, . . . , in synchronization with the amplifier control signal CSLA <i>.

In the “H” period of the column selection signal CSL <0>, data latched in the latch LatchIO <0> is read out to the data line pair L1 and L2 as the block data inputs BDin and BZDin via IOGate <0>. Then, the block data inputs Din and ZDin are transferred to the amplifier data line pair LA1 and LA2 in the amplifier part AM <i> during a period of “L” of the amplifier enable signal PAE <i>.

Subsequently, the signal on the amplifier data line pair LA1 and LA2 is amplified by the amplifier part 20 which becomes active during an “H” period of the amplifier enable signal PAE <i>, and the signal becomes amplified signal SA and SAB. Note that, in the “H” period of the amplifier enable signal PAE <i>, the connection transistors Q11 and Q12 are turned off and the data line pair L1 and L2 and the amplifier data line pair LA1 an LA2 are cut off from each other.

As a result, column output data Data <0> is obtained as the output L of the inverter G5 and the output LB of the inverter G6. The block data outputs BDout and BZDout, which are obtained immediately after that in synchronization with a rise to “H” in the amplifier control signal CSLA <i>, are output from the output gate part 21 as the block data inputs Din and ZDin of the following stage data block DB <i+1>. Note that the block data outputs BDout and BZDout of the data block DB <7> become the final data outputs Dout.

After that, the block data outputs BDout and BZDout of the data block DB <i> are similarly obtained in the order of the column output data Data <1>, Data <2>, Data <3>, and Data <4>.

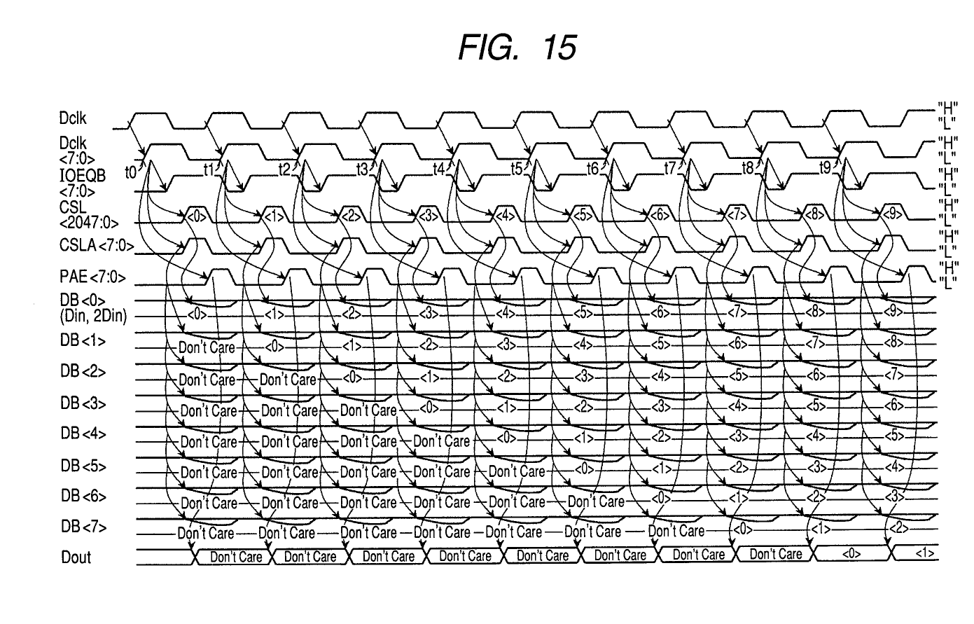

FIG. 15 is a timing chart showing data transfer operation waveforms among the data blocks DB <0> to DB <7> in the data bus part 11. Note that the data blocks DB <0> to DB <7> show the respective block data inputs BDin and BZDin in FIG. 15.

As shown in FIG. 15, the column selection signal CSL <0> becomes to exhibit “H” for a predetermined period at time t0 in synchronization with a rise in the digital clocks Dclk <7:0> based on the data clock Dclk, as in the operation of the data block DB <i> shown in FIG. 14, and the column output data Data <0> is read out from the data block DB <0>.

Subsequently, the column selection signal CSL <1> becomes to exhibit “H” for the predetermined period at time t1 in synchronization with the rise in the digital clocks Dclk <7:0>, as in the operation of the data block DB <i> shown in FIG. 14, and the column output data Data <1> is read out from the data block DB <0>. At the same time, the column output data Data <0> is amplified and read out by the amplifier part AM <1> of the data block DB <1>.

Then, the column selection signal CSL <2> becomes to exhibit “H” for the predetermined period at time t2 in synchronization with the rise in the digital clocks Dclk <7:0>, as in the operation of the data block DB <i> shown in FIG. 14, and the column output data Data <2> is read out from the data block DB <0>. At the same time, the column output data Data <0> is amplified and output by the amplifier part AM <2> of the data block DB <2>, and the column output data Data <1> is read out and output by the amplifier part AM <1> of the data block DB <1>.

After that, the column output data sets Data <3>, <4>, . . . , <9> are read out from the data block DB <0> in synchronization with the rises of the data clock Dclk at times t3, t4, . . . , and t9, respectively.

At the same time, the column output data sets Data < > having been read out from the preceding stage data blocks DB <0>, <1>, . . . , <6> are respectively read out from the data blocks DB <1>, <2>, . . . , <7>.

Then, the column output data Data <0> can be obtained from the data block DB <7> as the final data output Dout, at a rise in the amplifier enable signal PAE <7:0> in synchronization with the rise to “H” in the digital clocks Dclk <7:0> at the time t8.

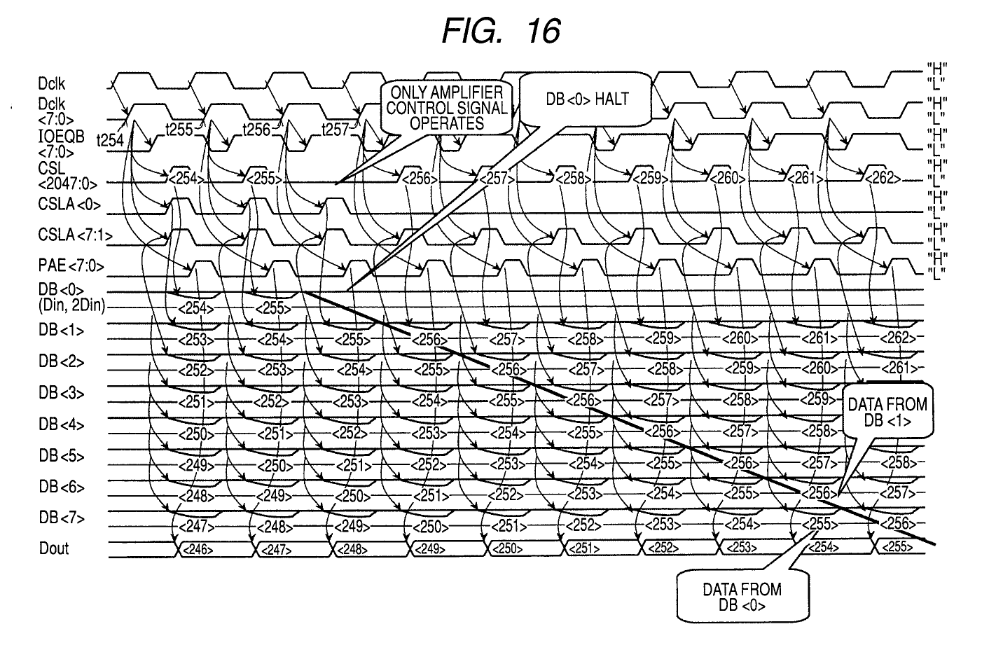

FIG. 16 is a timing chart showing data transfer operation waveforms among the data blocks DB <0> to DB <7> in the data bus part 11. Note that, in FIG. 16, the data blocks DB <0> to DB <7> show the block data inputs BDin and BZDin, respectively.

As shown in FIG. 16, the column selection signal CSL <254> exhibits “H” for the predetermined time in synchronization with the rise in the digital clocks Dclk <7:0> at time t254, as in the operation of the data block DB <i> shown in FIG. 14, and the column output data Data <254> is read out from the data block DB <0>. At the same time, the column output data sets Data <253>˜<247> are amplified and read out by the amplifier parts AM <1>˜<7> of the data blocks DB <1>˜<7>, respectively, and the column output data Data <246> is obtained as the data output Dout.

Next, the column selection signal CSL <255> exhibits “H” for the predetermined time in synchronization with the rise in the digital clocks Dclk <7:0> at time t255, as in the operation of the data block DB <i> shown in FIG. 14, and the column output data Data <255> is read out from the data block DB <0>. At the same time, the column output data sets Data <254>˜<248> are amplified and read out by the amplifier parts AM <1>˜<7> of the data blocks DB <1>˜<7>, respectively, and the column output data Data <247> is obtained as the data output Dout.

After that, the column selection signal CSL < > in the data block DB <0> exhibits “L” in a period synchronized with the rise in the digital clocks Dclk <7:0> at time t256. This is because the local counter LC <0> outputs the digital output AD <256> not as the column selection signal CSL < > but only as the transfer output signal C_OUT as shown in FIG. 12. At the same time, the column output data sets Data <255>˜<249> are amplified and read out by the amplifier parts AM <1>˜<7> of the data blocks DB <1>˜<7>, respectively, and the column output data Data <248> is obtained as the data output Dout.

Subsequently, in a period synchronized with the rise in the digital clocks Dclk <7:0> at time t257, the amplifier control signal CSLA <0> in the data block DB <0> exhibits fixed “L” (to be continued after that), and thereby the column selection signals CSL <255:0> in the data block DB <1> exhibit fixed “L”.

On the other hand, the local counter LC <1> takes in the transfer output signal C_OUT (“H”) of the data block DB <0> in a period after the time t256, and thereby the column selection signal CSL <256> (column selection signal CSL <0> in data block DB <1>) exhibits “H” for the predetermined period and the column output data Data <256> is read out from the data block DB <1>. At the same time, the column output data sets Data <255>˜<249> are amplified and read out by the amplifier parts AM <2>˜<7> of the data blocks DB <2>˜<7>, respectively, and the column output data Data <249> is obtained as the data output Dout.

After that, similarly the column output data sets Data <257>, <258>, . . . , <262> are read out from the data block DB <1> in synchronization with the rise in the digital clocks Dclk <7:0>.

At the same time, the column output data sets Data < > having been read out from the preceding stage data blocks DB <1>, <2>, . . . , <6> are sequentially read out from the data blocks DB <2>, <3>, . . . , <7>.

In this manner, one cycle of the un-activated column selection signal CSL < > is inserted between the column selection signal CSL <255> in the data block DB <0> and the column selection signal CSL <256> (local column selection signal CSL <0>) in the data block DB <1>. This is realized by a configuration of serially coupling the 257 D-flip-flops in each of the local counters LC <0> to LC <7> and outputting the Q-output of the 257th D-flip-flop as the transfer output signal C_OUT, as shown in FIG. 11 and FIG. 12.

As a result, the data blocks DB <0> and DB <1> adjacent to each other can be controlled so as not to have timing discontinuity also in switching the read-out between the corresponding latches LatchIO <255:0>. Further, since the amplifier control signal CSLA <0> in the data block DB <0> exhibits fixed “L” after the one cycle from the output of the column selection signal CSL <255>, the data block DB <0> does not output the column selection signal CSL <255:0> exhibiting “H” and thereby the block data output BDout from the data block DB <0> can be fixed to “L”.

As shown in FIG. 16, the 0th to 255th pixel data sets are output from the data block DB <0> belonging to the leftmost block, and the 256th to 511th pixel data seta are output from the data block DB <1> belonging to the second leftmost block. That is, there exists discontinuity of a pipe between the 255th pixel data and the 256th pixel data (between the blocks). However, since the local counters LC <0> and LC <1> perform the timing control of the data blocks DB <0> and DB <1>, respectively, such that the data transfer itself does not need to consider the pipe discontinuity, a particular time lag does not exist between 255th pixel data and the 256th pixel data which are obtained between the different data blocks DB <0> and DB <1>, respectively.

The above relationship between the data blocks DB <0> and DB <1> is similarly set between the adjacent blocks among the data blocks DB <2> to DB <7>. Accordingly, a column output signal DATA <2047:0> read out from the data blocks DB <0> to DB <7> can be output so as not to have the timing discontinuity.

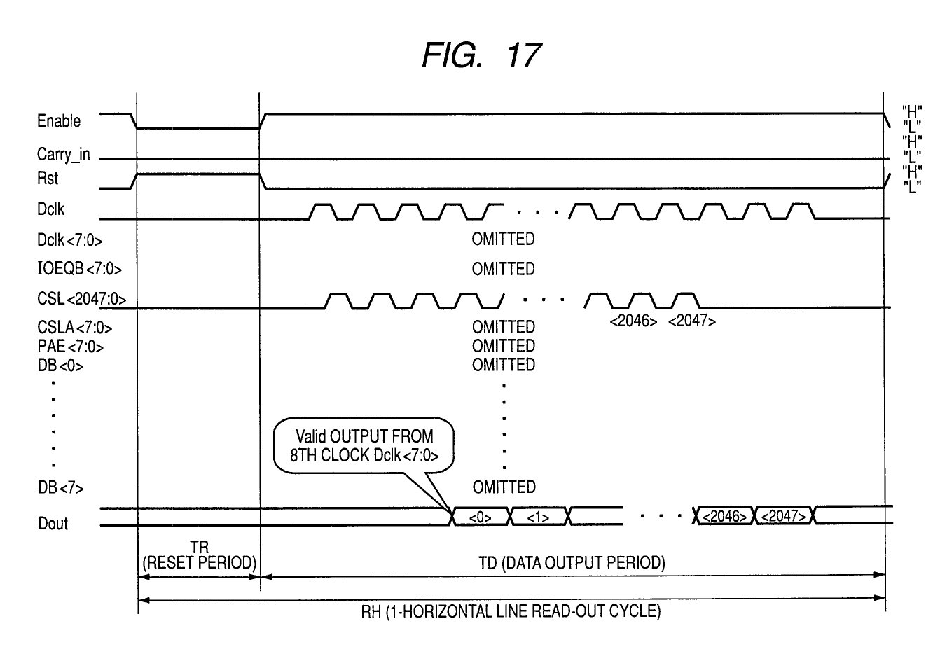

FIG. 17 is a timing chart showing entire data transfer operation waveforms among the data blocks DB <0> to DB <7>.

As shown in FIG. 17, a read-out cycle RH of one horizontal line is composed of a reset period TR (“L” in the enable signal Enable and “H” in the reset signal Rst) and a data output period TD after that (“H” in the enable signal Enable and “L” in the reset signal Rst). Note that the carry-in signal Carry_in exhibits fixed “L” for the whole period.

After the reset period TR and in the data output period TD, the column output data Data <0> is read out as the final data output Dout from the 8th digital clock Dclk <7:0> (corresponding to the digital clock Dclk <7:0> which exhibits a rise at the time t8 in FIG. 15). After that, the column output data Data <1>, . . . , Data <2046>, and Data<2047> are read out without discontinuity.

A pipe-line type data transfer method and advantages thereof will be summarized for the solid state imaging device of the above described embodiment. Features of this transfer method are as follows.

Feature 1: A pipe-line method having a total length of 36 mm/8 stages is employed by connecting the eight stages of the data block DB <i> each having a length of 4.5 mm/stage. Feature 2: The local counter LC <i> is disposed for each of the stages (each of the blocks) having a timing control signal generation function. Feature 3: The digital clock Dclk <i> which is a control clock for the local counter LC <i> in each of the stages is supplied from the clock distribution part 13 (generator) configured with equal-length wirings so as not to cause clock skew among the stages. Feature 4: A high-speed timing control signal is used only as the data clock Dclk which is input into the clock distribution part 13 and used as a reference clock for generating the digital clock Dclk <i>. Feature 5: A particular time lag does not exist in the data transfer across a boundary between the data blocks DB <i>.

Advantages obtained from the above features 1 to 5 are following Advantage A to Advantage D: Advantage A: high-speed data transfer capability; Advantage B: high expandability; Advantage C: design capability without consideration of detailed timing of the control signals; and Advantage D: no discontinuity between the data blocks <i> within the sensor to be considered by an external device on the data receiving side.

For above described Advantage A to Advantage D, first Advantage A will be described. Advantage A can be realized mainly by Feature 1 and Feature 2. That is, for realizing data transfer across a long distance of 36 mm in the horizontal direction as in a full-size sensor, a high data transfer rate cannot be realized by a method of simply disposing a wiring of 36 mm length (corresponding to the data transfer bus 15) to transfer data thereto.

As shown in FIG. 14, for transferring data accurately, the output data from the latch LatchIO < > (block input data BDin and BDZin) needs to have an amplitude more than a certain value (e.g., 100 mV or larger) on the data line pair L1 and L2 and the amplifier data line pair LA1 and LA2. Obviously, whatever long distance bus finally can obtain a detectable potential difference between the complementary nodes (L1 and L2 or LA1 and LA2) after a long waiting time. However, too long waiting time does not realize a high data transfer rate. The data transfer by a 200 MHz clock, for example, will be considered.

In FIG. 14, the data is transferred from the latch LatchIO < > to the data line pair L1 and L2 in synchronization with the digital clock Dclk <i>, which is the control clock of the local counter LC <1>, having a cycle time of 5 ns. That is, a substantial period in which the potential difference between the data line pair L1 and L2 increases is only the active period (“H” period) of the activated column selection signal CSL <s> among the column selection signals CSL <255:0>. In the case of the 5 ns cycle time in the digital clock Dclk <i>, the active period of the column selection signal CSL <s> becomes around 2 ns from various timing restrictions. Since the data line pair L1 and L2 and the amplifier data line pair LA1 and LA2 need to have the potential difference of 100 mV within a time of this 2 ns, the present embodiment realizes the data transfer by dividing the data transfer bus 15 required to have a total length of 36 mm into the data line pairs L1 and L2 (data transfer buses 15i) of the eight stage data blocks DB <i> respectively having a length of 4.5 mm. The long distance bus with a length of 36 mm has a too large wiring capacitance thereof and too large diffusion capacitances of the connection transistors and the sufficient potential difference cannot be obtained within 2 ns. However, this is possible in the bus having a length of 4.5 mm (data line pair L1 and L2). The data transfer bus 15 is divided by the data block DB <i> every 4.5 mm, and the data line pairs L1 and L2 in the adjacent data blocks DB <i> realize the long distance transfer across the total length of 36 mm while repeatedly amplifying the potential difference with the amplifier part AM <i> formed therebetween.

By such a configuration, although 8-clock latency is generated from the input of the digital clock Dclk <7:0> to the output of the first column output data Data <0> as shown in FIG. 15, for example, it is possible to realize a high data transfer rate of 200 Mbit/s after the first data output.

As described above, the data block DB <i> in the data bus part 11 of the CMOS image sensor in the present embodiment includes the data line pair L1 and L2, the amplifier part AM <i> coupled to the data line pair L1 and L2. Then, the amplifier part AM <i> amplifies the signal on the data line pairs L1 and L2 and outputs the amplified signal as the block data outputs BDout and BZDout at the timing indicated by the amplifier enable signal PAE <i> and the amplifier control signal CSLA <i> (second timing control signal). Further, the CMOS image sensor of the present embodiment has above Feature 1 of connecting the data blocks DB <0> to DB <7> so as to provide the preceding stage block data outputs BDout and BZDout to the following stage data line pair L1 and L2 as the block data inputs BDin and BZDin, respectively, from the first stage (DB <0>) to the last stage (DB <7>).

By above Feature 1, the present embodiment can obtain a detectable potential difference in a comparatively short time between the finely divided data line pair L1 and L2 in each of the data blocks DB <i>, and thereby has an advantage of performing a high-speed data transfer within the data bus part 11 and outputting the data to the outside in a high speed as the (final) data output Dout.

Next Advantage B will be described. Advantage B is realized mainly by Feature 2, Feature 3, and Feature 4. The present embodiment shows the transfer method by cutting the horizontal length of 36 mm for the assumed full size sensor into pipes (blocks) of 4.5 mm×8 stages. However, the method can be applied exactly in the same manner also to a case of a horizontal length of 24 mm for an assumed image sensor having a size called the DX size of approximately 24 mm×16 mm. In this case, there can be devised a method such as one of cutting the horizontal length into pipes (blocks) of 4 mm×6 stages, for example, and therefore re-design of the circuit is not necessary at all. The parts to be re-designed are the clock distribution part 13 and the local counter part 12, and the contents to be changed in these local counter part 12 and clock distribution part 13 are only layout designs for both cases.

Next Advantage C will be described. Advantage C can be realized mainly by Feature 2, Feature 3, and Feature 4. Since all of the control clocks (digital clock Dclk <7:0>) in the local counter LC <i>, which are high-speed timing signals, have a reference only to the data clock Dclk (refer to FIG. 2 and FIG. 3), timing skew care or the like in the long distance signal transfer does not exist inherently. It is difficult to realize the same timing skew among signals in the long distance signal wiring of 36 mm, and, if the same timing skew is tried to be realized, it requires a huge design time and labor force. Further, it is difficult to avoid a problem that only a low-yield product can be obtained as a result. The control signals necessary for the present embodiment are, for example, IOEQB <0-7>, CSL <0-2047>, PAE <0-7>, and CSLA <0-7> as shown in FIG. 2. Among these signals, the eight signals of IOQEB <0-7> are to be activated at exactly the same timing. PAE <0-7> and CSLA <0-7> are also the same. Further, IOEQB <i>, CSL, PAE <i>, and CSLA <i> in each of the data blocks DB <i> should have a fixed timing relationship as shown in FIG. 14.

When these control signals are transferred simply from the left side in FIG. 2 or FIG. 3 (side of data block DB <0>) to the data blocks DB <0> to DB <7>, for example, IOEQB <0> and IOEQB <7> have a large timing difference and the timing difference between IOEQB <0> and PAE <0> and the timing difference between IOEQB <7> and PAE <7> cannot be the same.

The present embodiment divides the horizontal length of 36 mm into 4.5 mm×8 stages by the data blocks DB <i> and also generates the necessary control signals locally for each of the blocks by outputting the signals for each of the blocks from the local counter LC <i> having the same configuration.

Although the timing between the signals certainly requires to be cared in the local counter LC <i> of each of the blocks, the horizontal length thereof is 4.5 mm and thereby it is very easy to adjust the timing compared to the long distance signal transfer for 36 mm.

As described above, each of the local counters LC <i> in the CMOS image sensor of the present embodiment outputs the first timing control signals (CSL <255:0>) indicating the timing of the data block DB <i> to read out the AD conversion comparison results CMP_in <2047:0> on the data line pair L1 and L2, by the control signal generation function. Further, the local counter LC <i> outputs the second timing control signals (PAE <i> and CSLA <i>) indicating the timing of the amplifier part AM <i> to amplify the data read out on the data line pair L1 and L2 and to obtain the block data outputs BDout and BZDout, by the above control signal generation function.

Thereby, the CMOS image sensor of the present embodiment has an advantage of accurately performing a high-speed data transfer within the data bus part 11 under the control of the local counter part 12.

Further, the digital clock Dclk <i>, which is the control clock (drive clock) of the control signal generation circuit part in each of the local counters LC <i>, can be obtained from the data clock Dclk through the equal-length wirings in the clock distribution part 13, and thereby the inter-block timing difference is not generated in principle.

That is, the clock distribution part 13 receives the data clock Dclk which is the reference clock, and distributes this data clock Dclk via the equal-length wirings as the digital clocks Dclk <0> to Dclk <7>.

Accordingly, the timing difference is not generated among the digital clocks Dclk <0> to Dclk <7>, and thereby the local counter LC <i> can accurately generate the control signals such as the column selection signal CSL <255:0>, the amplifier enable signal PAE <i>, and the amplifier control signal CSLA <i>.

Finally, Advantage D will be described. Advantage D is realized mainly by Feature 5. As shown in FIG. 3 and FIG. 15, a clock number required for the data to reach the data output Dout of the final output (data latency), while being eight clocks for the data <0-255> of the leftmost data block DB <0>, is seven clocks for the data <256-511> of the second data block DB <1> from the left and 1 clock for the data <1792-2047> of the rightmost data block DB <7>.

Since the data latency is different for each data block DB <i> in this manner, if design is carried out without any care, the last data <255> of the leftmost data block DB <0> and the first data <256> of the second data block <1> from the left, for example, would collide each other when transferred to the data line pair L1 and L2 in the data block DB <1>.

Actually, however, the present embodiment realizes the smooth transfer without the collision of the data across the block boundary nor time lag under the timing control of the local counter LC <i> as shown in FIG. 16. This is because the activation timings of CSL <255> and CSL <256> have an additional one clock space therebetween, as shown in FIG. 16. Further, this is because CSLA <0> is interrupted after the transfer of the data <255> to DB <1>. Such pipe-end processing is realized by the local counter LC <0> to LC <7> shown in FIG. 10 to FIG. 12. For the 256 data sets belonging to each of the blocks, each of the local counters LC <0> to LC <7>, shown in FIG. 11 and FIG. 12, has 257 shift register circuits (D-flip-flops DFF <256:0> in FIG. 11 or D-flip-flop 29+D-flip-flops DFF <256:1> in FIG. 12). That is, it is possible intentionally to delay the generation of the first column selection signal CSL < > in the following stage data block DB <i> by one clock, by providing one additional shift register.

Further, by the addition of the D-flip-flop 24 in FIG. 11 and the D-flip-flop 30 in FIG. 12, the generation of the amplifier control signal CSLA <i> can be interrupted after whole necessary data has been sent out. It is possible to realize the seamless data transfer as shown in FIG. 15 and FIG. 16 by providing such an end processing circuit in the local counter LC <i> disposed for each of the pipes.

As described above, each of the local counters LC <i> divides the AD conversion comparison results CMP_in <2047:1792> to be read out to the data line pairs L1 and L2 in the data blocks DB <i> in the order from the first stage to the last stage. Further, the local counter LC <i> outputs the timing control signal such as the column selection signals CSL <255:0> and the amplifier control signal CSLA <i> so as not to cause the timing discontinuity when switching the data line pair L1 and L2 to receive the read out data to the following stage data line pair L1 and L2.

As a result, the CMOS image sensor of the present embodiment can output the data output Dout from the data bus part 11 without discontinuity. Accordingly, a user side utilizing the data output Dout may only carry out simple processing assuming that the data <2047:0> is output sequentially without discontinuity.

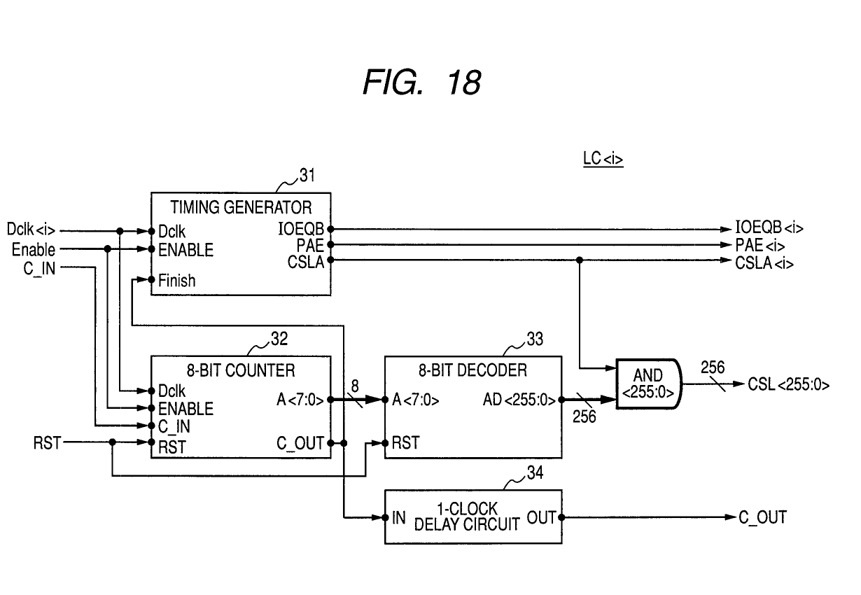

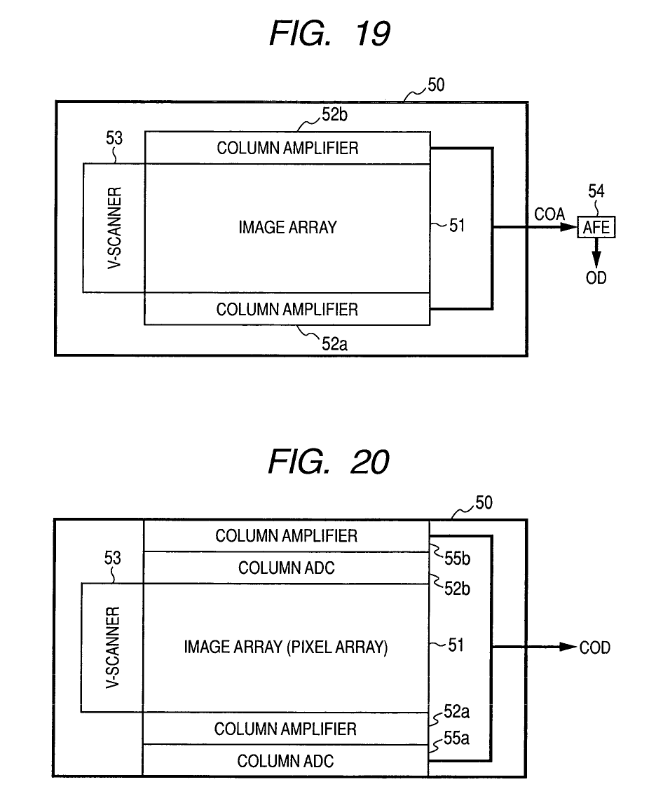

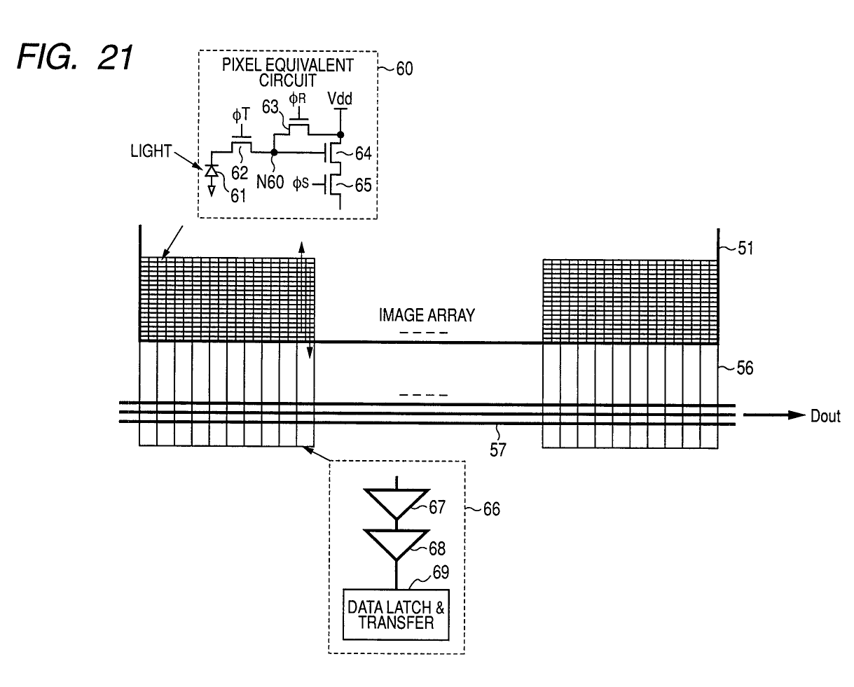

(Modification) FIG. 18 is a circuit diagram showing an internal configuration for another configuration example of the local counter LC <i> (i=any of 0 to 7) with the 256×1 bit configuration shown in FIG. 10.

As shown in the drawing, the local counter LC <i> is configured with a timing generator 31, an 8-bit counter 32, an 8-bit decoder 33, a 1-clock delay circuit 34, and 256 AND gates AND <255:0>.

The timing generator 31 receives the data clock Dclk <j> and the enable signal Enable to be activated when the enable signal Enable exhibits “H”, and outputs the equalization output IOEQB <j>, the amplifier enable output PAE <j>, and the amplifier control signal CSLA <i>. The equalization output IOEQB, the amplifier enable output PAE <j>, and the amplifier control signal CSLA <i> switch “H” and “L” at a predetermined timing in synchronization with the data clock Dclk <j>.

Note that the timing generator 31 of the local counter LC <0> takes in the carry-in signal Carry_in as the transfer input signal C_IN. In this case, the carry-in signal Carry_in is a signal having fixed “H”.

The 8-bit counter 32 receives the data clock Dclk <i> and the enable signal Enable to be activated when the enable signal Enable exhibits “H”, and counts the clock number of the data clock Dclk <i> triggered by “H” detection of the transfer input signal C_IN and output 8-bit count outputs A <7:0>.

Further, the 8-bit counter 32 initializes the count outputs A <7:0> to “0” when the reset signal Rst exhibiting “H” is input, and outputs the transfer output signal C_OUT exhibiting “H” when all the bits (255) of the count outputs A <7:0> indicate “1”.

The timing generator 31 inputs the transfer output signal C_OUT exhibiting “H” of the 8-bit counter 32 into a Finish input part, and then makes the amplifier control signal CSLA <j> exhibit fixed “L” in the next cycle.

The 8-bit decoder 33 receives the count outputs A <7:0>, and sets only one bit among the digital outputs AD <255:0> to be “H” according to the count outputs A <7:0>. Further, the 8-bit decoder 33 is initialized when the reset signal Rst exhibiting “H” is input and makes all the digital outputs AD <255:0> be “0”.

The 1-clock delay circuit 34 receives the transfer output signal C_OUT of the 8-bit counter 32 at an input IN, and outputs the transfer output C_OUT of the local counter LC <i> from an output part OUT after providing one clock delay.

The respective 256 AND gates AND <255:0> commonly receive the amplifier control signal CSLA at one side inputs and receive the corresponding digital outputs AD <255:0> at the other side inputs, and output the 256 column selection signals CSL <255:0> which are logical products of the one side inputs and the other side inputs, respectively.

Note that FIG. 18 illustrates the 256 AND gates AND <0> to AND <255> in a lump as the AND gates AND <255:0> for convenience.

In this manner, the local counter LC <i> can be configured with the 8-bit counter 32 and the 8-bit decoder 33.

Further, it is also possible to configure the local counter LC <i> to read out thinned-out data such as one omitting every other bit, by further improving the local counter LC <i> shown in FIG. 18. That is, it is effective to use the local counter LC <i> capable of the thinning-out read-out in a camera device which prioritizes high-speed read-out even by slightly sacrificing image quality. The thinning-out read-out can be realized also by improving the local counter LC <i> shown in FIG. 11 and FIG. 12.

In addition, by further improving the local counter LC <i> shown in FIG. 18, it is possible to obtain a configuration of selectively reading out only the pixel data in a predetermined area from the pixel array 1.

What is claimed is:

1. A solid state imaging device, comprising:
a pixel array part capable of outputting a plurality of pixel data sets in a lump after A/D conversion; and
a digital output circuit taking in the pixel data sets and sequentially outputting the pixel data sets as a final data output,
wherein the pixel data sets are divided into a predetermined number of divided pixel data groups,
wherein the digital output circuit includes a data bus part having a predetermined number of data blocks which take in the predetermined number of divided pixel data groups,
wherein each of the predetermined number of data blocks includes a data line for reading out the corresponding divided pixel data group, and an amplifier part amplifying a signal of the data line at a predetermined timing and outputting the amplified signal as a block data output,
wherein the predetermined number of data blocks are coupled with each other from the first stage to the last stage so that the block data output of a preceding stage can be provided to the data line of a following stage as a block data input, and
wherein the block data output of the data block at the last stage becomes the final data output.

2. The solid state imaging device according to claim 1,
wherein the digital output circuit further includes a timing control signal generation part having a predetermined number of local counters provided corresponding to the predetermined number of data blocks, and
wherein each of the predetermined number of local counters has a control signal generation function of outputting a first timing control signal which indicates timing for sequentially reading out the pixel data in the corresponding divided pixel data group onto the data line and of outputting a second timing control signal indicating timing for amplifying the data read-out onto the data line by the amplifier part to obtain the block data output.

3. The solid state imaging device according to claim 2,
wherein the digital output circuit further includes a clock distribution part distributing a predetermined number of control clocks to the predetermined number of local counters, and
wherein the clock distribution part receives a reference clock, and distributes the predetermined number of control clocks by distributing the reference clock by equal-length wirings.

4. The solid state imaging device according to claim 3,
wherein the predetermined number of local counters output the first and second control signals to the predetermined number of data blocks, respectively, so as to read out the predetermined number of divided pixel data groups onto the corresponding data lines in order from the first stage to the last stage and also so as not to generate timing discontinuity when the data line to receive the read-out data is switched to the data line of the following stage.
